(19) United States
(12) Patent Application Publication
(10) Pub. No.: US 2026/0222848 A1
(43) Pub. Date: Jul. 30, 2026

(54) DECENTRALIZED BLOCKCHAIN INFRASTRUCTURE INCLUDING NON-TERRESTRIAL NETWORKS FOR INTERNET OF THINGS (IOT) DEVICES

(71) Applicant: T-Mobile USA, Inc., Bellevue, WA (US)

(72) Inventors: Srinivasa Chinimilli, Sammamish, WA (US); Anbalagan Elumalai, Issaquah, WA (US)

(21) Appl. No.: 19/039,727

(22) Filed: Jan. 28, 2025

(51) Int. Cl. H04W 24/04; G16Y 10/75

(52) U.S. Cl. CPC H04W 24/04; G16Y 10/75

(57) ABSTRACT

A system is enabled to manage sensor data from multiple Internet of Things (IoT) devices over a wireless terrestrial network (TN) connected to a non-terrestrial network (NTN) with satellites. The system communicates sensor data to a blockchain network comprising terrestrial and non-terrestrial nodes, initiates a consensus protocol to record data blocks, and handles failed consensus attempts by re-effectuating the protocol until a specified event occurs. The system also processes location data, configures applications to use blockchain-stored data, and ensures low-latency communication via satellite links. The IoT devices can form a mesh network or transmit data directly to the blockchain's non-terrestrial nodes, enhancing data integrity and reliability across diverse network infrastructures.

### BACKGROUND

Non-terrestrial networks (NTNs) are wireless communication systems that utilize satellites, high-altitude platforms, and/or drones to connect devices in various environments, including aerial, maritime, and terrestrial settings. NTNs aim to enhance global communication coverage, particularly in remote regions, by offering an alternative to or complementing terrestrial networks.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates peer nodes of a blockchain network including terrestrial and non-terrestrial nodes.

FIG. 3 is a block diagram that illustrates a wireless communications system configured to store and process Internet of Things (IoT) data maintained on a blockchain network including terrestrial and non-terrestrial nodes.

FIG. 4 illustrates an architecture of an orchestration engine.

FIG. 5 is a flowchart that illustrates a method for storing and processing IoT data maintained on a blockchain network including terrestrial and non-terrestrial nodes.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to techniques for storing and processing data on a blockchain network that includes a terrestrial network (TN) and a non-terrestrial network (NTN). The TN includes terrestrial nodes and the NTN includes non-terrestrial nodes such as satellites. The blockchain network can include communication wired or wireless links between terrestrial nodes and non-terrestrial nodes. The links can intermittently or permanently connect the nodes of the TN and NTN. The blockchain network stores data obtained at Internet-of-Things (IoT) devices such as sensor data or location data. The data obtained from the IoT devices is stored in blocks on the blockchain network including the non-terrestrial nodes, which connect intermittently to the terrestrial nodes. Storing the data at the NTN prevents data loss and aids in data recovery in the event of external problems affecting terrestrial networks, for example.

The IoT devices are on a terrestrial network that can send data regularly (e.g., periodically) or on demand to a data store in a low-energy manner with low latency to keep a data store updated with information collected from the IoT devices over time. As a result, the data store can be reliably queried for up-to-date information computed from the data collected from the IoT devices. However, in the event of a regular intermittent connection, a natural disaster, or another event disturbing a connection on the terrestrial network, the IoT devices on the terrestrial network may not be able to connect and send updated data to the data store, and the data store may no longer become a source of truth for up-to-date data.

To avert data loss and aid in data recovery, the disclosed technology includes a distributed ledger with nodes on a TN and an NTN that are used to maintain a distributed data store (e.g., blockchain) for critical IoT device data. In addition to recurring data communication with terrestrial networks, IoT devices can send data to non-terrestrial networks such that the same data is available in the event that a terrestrial network becomes inaccessible. Once the terrestrial network connection is restored, the non-terrestrial network can synchronize with the terrestrial network to update each data store and maintain an updated source of truth.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

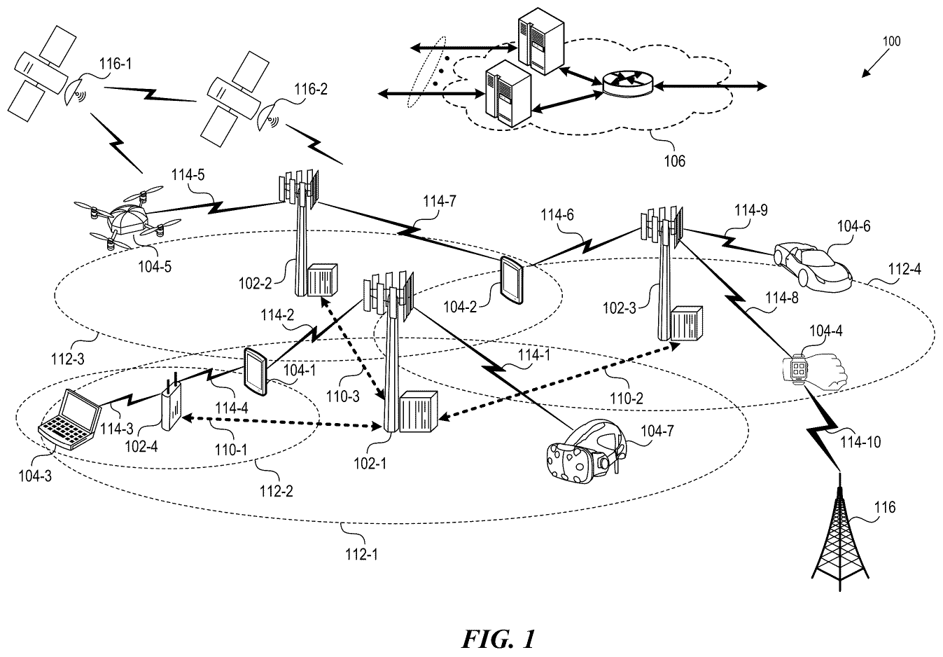

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Blockchain Network

The blockchain network of the disclosed technology stores a record of transactions that are maintained across nodes of an TN and NTN that are permanently or intermittently linked in a peer-to-peer network. In one example, a digital distributed ledger stores copies of digital records of IoT data among nodes of a TN and NTN, where the entries are stored in blocks of the ledger that are cryptographically related. A public blockchain is a common example of a distributed ledger that can record transactions between parties in a verifiable and permanent way. Thus, a blockchain network has a decentralized, distributed database where a ledger is maintained by peer nodes. Hence, an intermediary is not required to maintain the blockchain. The IoT data can be authenticated with cryptographic hashing and mining techniques.

The disclosed blockchain network is analogous to a distributed database on a distributed computing network that maintains a continuously growing list of ordered records called blocks. A block of a blockchain includes records of IoT data, transactions, or other recorded data (e.g., handle data). Each block contains at least one timestamp, and a block links to a previous block to thus form a chain of blocks. Blockchains are inherently resistant to modification of their recorded data. That is, once recorded, the data in a block cannot be altered retroactively. Through a peer network and distributed timestamping, a blockchain is managed in an autonomous manner.

Decentralized consensus can be achieved with a blockchain. This makes blockchains suitable for recording IoT events, condition records, other records management activities, identity management, transaction processing, and proving data provenance. These types of networks provide a pragmatic solution for arriving at a consensus in the face of trust and timing problems typically encountered in distributed networks.

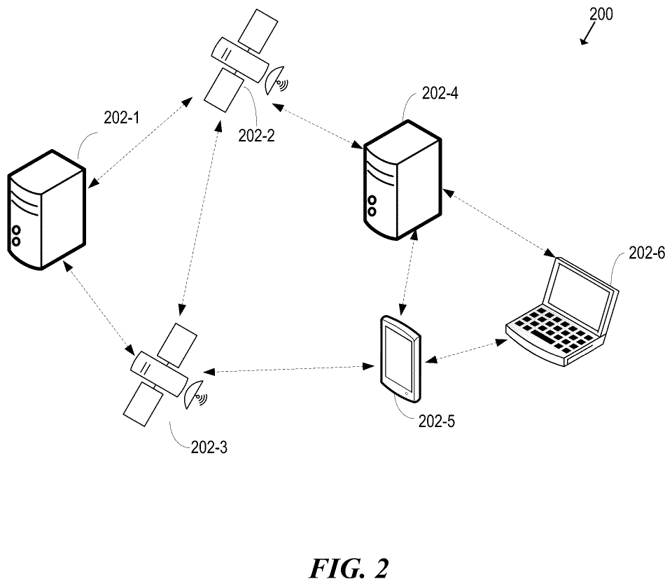

FIG. 2 illustrates a network 200 of interconnected peer nodes 202-1 through 202-6 (also referred to collectively as “peer nodes 202” and individually as “peer node 202”). The peer nodes 202 can be distributed across various geographic locations including regions all over the world and in space. The network 200 can include a combination of private, public, wired, or wireless portions. Data communicated over the network 200 can be encrypted or unencrypted at various locations or portions of the network 200. Each peer node 202 can include combinations of hardware and/or software to process data, perform functions, communicate over the network 200, and the like.

The peer nodes 202 can include devices on TN and NTN networks. Examples include terrestrial servers 202-1 and 202-4, satellites 202-2 and 202-3, handheld mobile devices 202-5, portable computing devices 202-6, and any other electronic device that is capable of storing IoT data on a node of a blockchain. Any node of the network 200 can include a processor, memory or storage, a network transceiver, an operating system and application software, and the like. Other components, hardware, and/or software included in the network 200 that are well known to persons skilled in the art are not shown or discussed herein for the sake of brevity.

The network 200 can implement a blockchain that allows for the secure management of a shared ledger, where IoT data are verified and stored on the network 100 without necessitating a governing central authority. Blockchains can be implemented in different configurations, ranging from public, open-source networks, to private blockchains that require explicit permission to read or write transactions. Central to a blockchain are cryptographic hash functions that secure the network 200, in addition to enabling transactions, to protect a blockchain's integrity and anonymity.

The network 200 uses cryptography to securely process IoT data. For example, public-key cryptography uses asymmetric key algorithms, where a key used by one party to perform either encryption or decryption is not the same as the key used by another in the counterpart operation. Each party has a pair of cryptographic keys: a public encryption key and a private decryption key. For example, a key pair used for digital signatures consists of a private signing key and a public verification key. The public key can be widely distributed, while the private key is known only to its proprietor. The keys are related mathematically, but the parameters are chosen so that calculating the private key from the public key is unfeasible. The keys could be expressed in various formats, including hexadecimal format.

### System Overview

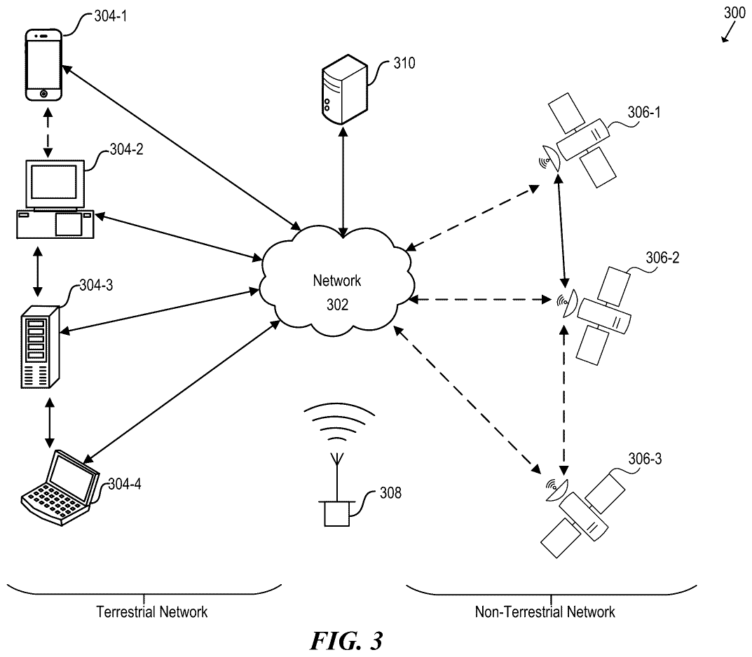

FIG. 3 is a block diagram that illustrates a wireless communications system configured to store and process IoT data maintained on a hybrid of blockchain networks including terrestrial and non-terrestrial nodes. The nodes of a data store of the hybrid blockchain networks can include satellites of the NTN in addition to nodes of the TN (individually and collectively referred to as the “blockchain”). The data on the blockchain nodes is secure due to the immutable property of the blockchain, which only allows new data to be added if consensus is reached on the nodes of the blockchain.

As shown, the system 300 includes nodes on the NT and NTN networks that form a network 302 with intermittent links for a decentralized data store. Although the system 300 illustrates a common point of data exchange at the network 302, embodiments include a configuration such as a mesh network. A mesh network is a decentralized network topology where each node connects to multiple other nodes, forming a web-like structure. This network design ensures efficient data routing, redundancy, and scalability. Key features include self-healing capabilities, allowing the network to reroute data if a node fails, and dynamic configuration, which adjusts to changes automatically. The mesh network can use specialized routing protocols to determine optimal data paths for data that is distributed to nodes of the blockchain.

The TN of the system 300 depicts examples of terrestrial nodes 304 of the blockchain as a mobile phone 304-1, a desktop computer 304-2, a server 304-3, and a laptop computer 304-4. The terrestrial nodes 304 form temporary or permanent links of the blockchain network. The links of the blockchain are depicted in system 300 as arrows between the terrestrial nodes 304 and the network 302, as well as links directly between the terrestrial nodes 304. The NTN of the system 300 depicts examples of non-terrestrial nodes 306 of the blockchain as satellites 306-1, 306-2, and 306-3. The non-terrestrial nodes 306 form temporary or permanent links of the blockchain. The links are depicted as dashed (temporary) or solid (permanent) arrows between the non-terrestrial nodes 306 and the network 302, as well as links directly between the non-terrestrial nodes 306. Links between and among various nodes of the blockchain can be permanent or temporary (e.g., intermittent) in various configurations, not shown in the illustration for the sake of brevity.

The system 300 can include wireless and wired IoT devices that generate data that can be stored on the blockchain. The system depicts a single IoT device 308 for the sake of brevity, however, IoT devices can encompass a wide array of physical devices embedded with sensors, software, and other technologies that enable them to connect and exchange data with other devices and systems over networks. The IoT devices range from everyday household items, such as smart thermostats and wearable fitness trackers, to complex industrial machinery and smart city infrastructure.

The IoT devices can generate a diverse range of data types. Environmental data, such as temperature, humidity, air quality, and light levels, can be collected to monitor and control living and working conditions. Location data, including GPS coordinates and movement patterns, is essential for tracking and navigation purposes. Usage data, which includes device usage statistics, operational status, and performance metrics, helps in optimizing the functionality and efficiency of the IoT devices. Health data, such as heart rate, blood pressure, and other biometric information, is crucial for personal health monitoring and medical applications. Additionally, audio and visual data, including images, videos, and sound recordings, can be captured for security, communication, and entertainment purposes.

The communication of data generated by IoT devices to terrestrial networks can be achieved through various methods. Wi-Fi is commonly used in home and office environments for high-speed data transfer. Bluetooth facilitates short-range communication between devices. Cellular networks, including 3G, 4G, and 5G, enable wide-area connectivity, particularly for mobile IoT devices. Ethernet provides wired connections for stable and secure data transfer in fixed locations. Low Power Wide Area Network (LPWAN) technologies, such as LoRa and Sigfox, are employed for long-range communication with low power consumption.

In scenarios where terrestrial networks are unavailable or unreliable, IoT devices can communicate data to non-terrestrial networks. Satellite communication offers global coverage, which is essential for remote or maritime IoT applications. Devices can utilize low Earth orbit (LEO) satellites to achieve lower latency and higher data rates. High-altitude platforms (HAPs), which are stratospheric platforms acting as pseudo-satellites, can provide wide-area coverage and lower latency compared to traditional satellites.

In the event that a particular link between nodes is disrupted, data can be routed via other links between or among the NT and NTN networks and/or temporarily stored or held at a node until the link is restored. As such, IoT data stored at a satellite of the blockchain can serve as proof of the data successfully being added to the blockchain. When the link is restored, the other nodes of the networks can run a consensus algorithm to synchronize the IoT data across the blockchain.

As shown, the system 300 includes an orchestration engine 310 that is configured to manage IoT data storage on the blockchain. The orchestration engine 310 can coordinate routing of IoT data between nodes of both terrestrial and non-terrestrial networks, addressing the challenges posed by intermittent network links due to terrestrial events, such as natural disasters, or the movement of satellites relative to terrestrial nodes of the blockchain. The IoT device 308 can communicate data to the nearest available node using appropriate communication methods. For instance, devices in urban areas may use Wi-Fi or cellular networks to connect to terrestrial nodes, while devices in remote or maritime locations may use satellite communication to connect to non-terrestrial nodes.

The orchestration engine 310 can manage the flow of data between these nodes. It monitors the status of network links and dynamically adjusts the routing of data to ensure continuous and reliable data transmission. For example, when a terrestrial event, such as a natural disaster, disrupts network connectivity, the orchestration engine 310 reroutes data through available non-terrestrial nodes, such as satellites or high-altitude platforms (HAPs). Similarly, when satellites move and lose connection to terrestrial nodes, the orchestration engine 310 identifies alternative routes to maintain data flow.

Upon receiving data, each node acts as a data collector, temporarily storing the data. The node then validates the data's integrity and authenticity using cryptographic techniques, ensuring that only legitimate and accurate data is added to the blockchain. Validated data is grouped into blocks, with each block containing a set of data entries, a timestamp, and a cryptographic hash of the previous block, ensuring a secure and immutable chain of records.

In one example, the networks in FIG. 3 can employ a consensus mechanism, such as Proof of Stake (PoS) or Practical Byzantine Fault Tolerance (PBFT), to agree on the validity of new blocks. Both terrestrial and non-terrestrial nodes participate in this process, ensuring a decentralized and distributed consensus. Once a block is validated, it is propagated across all nodes in the network. Terrestrial nodes distribute the block via high-speed internet connections, while non-terrestrial nodes use satellite links to ensure global coverage.

Authorized entities can access the blockchain to retrieve data for analysis, monitoring, and decision-making purposes. This blockchain network, enhanced by the orchestration engine, leverages both terrestrial and non-terrestrial nodes to receive data from IoT devices and distribute it securely and efficiently across the blockchain, ensuring global data integrity and availability despite network intermittencies.

The orchestration engine 310 is integral to the consensus mechanism of the hybrid blockchain networks, ensuring efficient data flow, coordination, and synchronization between terrestrial and non-terrestrial nodes. It dynamically assigns roles to nodes, such as proposers or validators, based on real-time assessments of computational capabilities, network latency, and health metrics. By actively monitoring network conditions, the orchestration engine 310 reroutes data to maintain node participation during failures or intermittent connectivity, thereby ensuring continuity in the consensus process.

The orchestration engine 310 facilitates consensus execution by preprocessing and validating data using cryptographic techniques such as digital signatures, hash functions, and zero-knowledge proofs to minimize invalid entries and optimize block formation. During consensus execution, the orchestration engine 310 can employ predictive analytics to reduce latency, particularly for satellite-based nodes, and implements retry mechanisms to recover from failed attempts. Post-consensus, the orchestration engine 310 ensures that all nodes synchronize their blockchain states, maintaining consistency and reliability across the network. This comprehensive approach enhances scalability, security, and resilience in hybrid blockchain ecosystems. Thus, the orchestration engine 310's multifaceted role in managing node interactions, data validation, and network resilience can be crucial for the effective implementation of consensus mechanisms in complex blockchain environments.

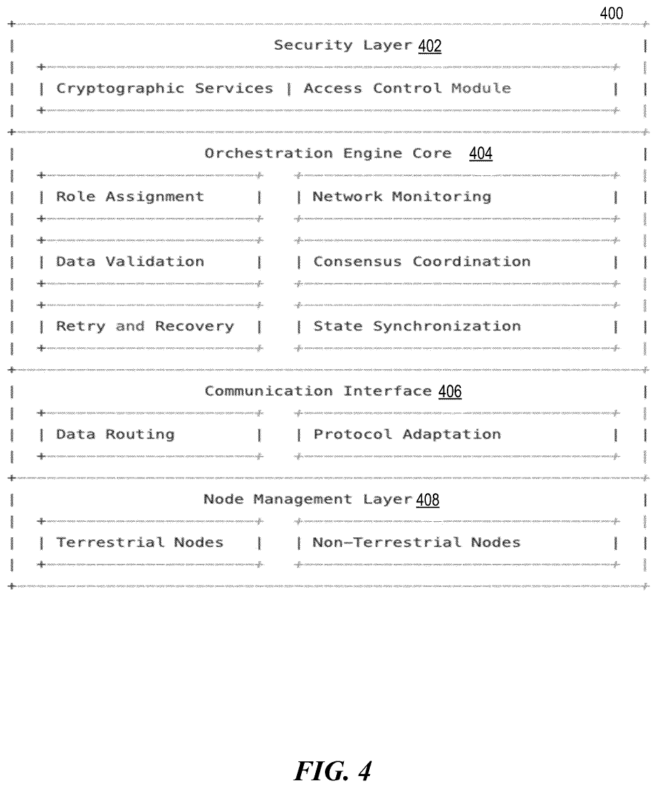

FIG. 4 illustrates an architecture of an orchestration engine 400. The orchestration engine 400 has components including a security layer 402, an orchestration engine core 404, a communication interface 406, and a node management layer 408.

The security layer 402 is fundamental in ensuring the confidentiality, integrity, and security of the data handled within the blockchain network. It includes two modules: the cryptographic services module and the access control module. The cryptographic services module is responsible for executing various cryptographic algorithms, such as digital signatures, hashing, and encryption/decryption operations. These ensure that the information exchanged between nodes is secure and that data integrity is maintained. On the other hand, the access control module manages permissions and credentials, ensuring that only authorized nodes and users can access specific data and functionalities within the network. This module enforces stringent access control policies to prevent unauthorized access and data breaches, contributing to the overall security posture of the blockchain infrastructure.

The orchestration engine core 404 houses several modules dedicated to the efficient management and operation of the blockchain network. These include the role assignment module, which dynamically assigns roles such as validators, proposers, and observers to different nodes based on their current availability and computational capability. The data validation module verifies the accuracy and consistency of incoming data before it is added to the blockchain, thus preventing the inclusion of invalid or fraudulent data. The retry and recovery module implements mechanisms to handle network disruptions or node failures, ensuring that the consensus process can recover and continue smoothly in the event of an issue. The network monitoring module continuously tracks the health and performance of the network, providing real-time insights and alerts on potential issues. The consensus coordination module manages the consensus algorithm, coordinating between nodes to achieve agreement on the addition of new blocks. Lastly, the state synchronization module ensures that all nodes maintain a consistent state of the blockchain, synchronizing data across terrestrial and non-terrestrial nodes to achieve a unified, up-to-date ledger.

The communication interface 406 of the orchestration engine 400 includes both the data routing module and the protocol adaptation module. The data routing module optimizes the path that data takes through the network, ensuring that it reaches its destination efficiently and with minimal latency. This is particularly important in hybrid networks comprising both terrestrial and non-terrestrial nodes. The protocol adaptation module facilitates seamless communication between different types of networks and devices, adapting various communication protocols to ensure compatibility and interoperability within the network. The node management layer 408 encompasses the terrestrial nodes and non-terrestrial nodes such as satellites and high-altitude platforms. This layer is responsible for managing and coordinating these nodes, ensuring their proper integration into the blockchain network. It handles node registration, deregistration, and health monitoring, maintaining the overall structure and functionality of the blockchain. By integrating both terrestrial and non-terrestrial nodes, the orchestration engine 400 achieves a robust, resilient network capable of maintaining continuous operation and data integrity across diverse environments.

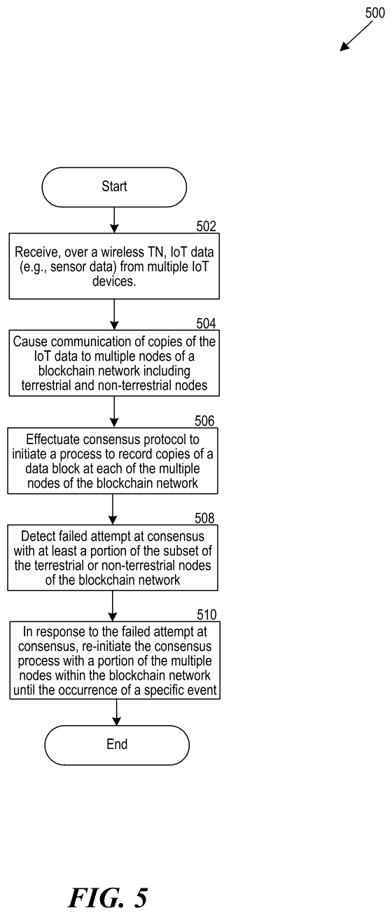

FIG. 5 illustrates a flowchart that depicts method 500 for storing and processing IoT data on a blockchain network including both terrestrial and non-terrestrial nodes. In certain embodiments, one or more non-transitory computer-readable storage media contain recorded instructions that, when executed by at least one data processor of a system, cause the system to execute method 500. This system can include an orchestration engine and nodes from terrestrial and/or non-terrestrial networks.

At 502, the system can receive, over a wireless TN, IoT data (e.g., sensor data) from multiple IoT devices, where the TN includes one or more terrestrial nodes and is configured to couple to an NTN that includes one or more satellites. In one example, the multiple IoT devices form a mesh network configured to communicate the IoT data with intermediary terrestrial nodes that can relay the IoT data directly to the one or more satellites. In one example, the multiple IoT devices are configured to transmit the IoT data directly to the non-terrestrial nodes of the blockchain network.

At 504, the system can cause communication of copies of the IoT data to multiple nodes of a blockchain network including at least a subset of the terrestrial nodes and non-terrestrial nodes. The system can also cause direct communication of the IoT data using satellite links between satellites of the blockchain network, where a consensus protocol is configured for low-latency communication over the satellite links.

At 506, the system can effectuate the consensus protocol to initiate a process to record copies of a data block at each of the multiple nodes of the blockchain network. The data block is a block of the blockchain that includes at least an indication of the IoT data. In one example, the system receives location data of the IoT devices in addition to sensor data. The system causes communication of copies of the location data to the multiple nodes of a blockchain network, and effectuates the consensus protocol to initiate the process to record copies of the data block, including the location data in addition to the sensor data, at each of the multiple nodes of the blockchain network.

At 508, the system can detect a failed attempt at consensus with at least a portion of the subset of the terrestrial nodes or non-terrestrial nodes of the blockchain network. The system can configure applications of devices using the wireless TN to use sensor data stored at multiple nodes of the blockchain network other than the portion of the subset of the terrestrial nodes and non-terrestrial nodes that failed consensus.

At 510, in response to the failed attempt at consensus, the system can re-initiate the consensus process with a portion of the multiple nodes within the blockchain network until the occurrence of a specific event. For instance, the system can identify a failed consensus with one or more satellites and subsequently re-initiate the consensus protocol with those satellites. Similarly, the system may detect a failed consensus with one or more terrestrial nodes and respond by re-initiating the consensus protocol with those nodes.

In one example, the system determines that a specified time period has elapsed, where the event corresponds to the expiration of this time period. Upon determining that the time period has expired, the system may terminate the subsequent instance required to initiate the consensus protocol with the blockchain network. Alternatively, the system can determine that consensus was successful, where the event corresponds to the determination that consensus was successful. In such cases, upon confirming successful consensus, the system terminates re-effectuating the consensus protocol with the blockchain network.

### Computer System

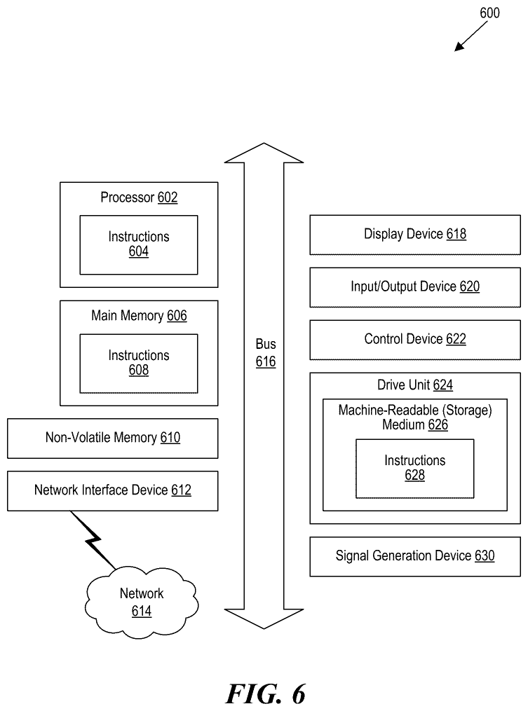

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions when executed by at least one data processor of a system, cause the system to:
receive, over a wireless terrestrial network (TN), sensor data from multiple Internet of Things (IoT) devices,
wherein the TN includes one or more terrestrial nodes and is configured to couple to a non-terrestrial network (NTN) that includes one or more satellites;
cause communication of copies of the sensor data to multiple nodes of a blockchain network including at least a subset of the terrestrial nodes and non-terrestrial nodes;
effectuate a consensus protocol to initiate a process to record copies of a data block at each of the multiple nodes of the blockchain network,
wherein the data block is a block of the blockchain that includes at least an indication of the sensor data;
detect a failed attempt at consensus with at least a portion of the subset of the terrestrial nodes or non-terrestrial nodes of the blockchain network; and
in response to the failed attempt at consensus, re-effectuate the consensus with the at least the portion of the multiple nodes of the blockchain network until occurrence of an event.

2. The non-transitory, computer-readable storage medium of claim 1, wherein the system is further caused to:
receive location data of the IoT devices in addition to the sensor data;
cause communication of copies of the location data to the multiple nodes of a blockchain network; and
effectuate the consensus protocol to initiate the process to record copies of the data block, including the location data in addition to the sensor data, at each of the
multiple nodes of the blockchain network.

3. The non-transitory, computer-readable storage medium of claim 1, wherein the system is caused to:
determine a failed consensus with the one or more satellites; and
in response to the failed attempt of consensus with the one or more satellites, re-effectuate the consensus protocol with the one or more satellites.

4. The non-transitory, computer-readable storage medium of claim 1, wherein the system is caused to:
determine a failed consensus with the one or more terrestrial nodes; and
in response to the failed consensus with the one or more terrestrial nodes, re-effectuate the consensus protocol with the one or more terrestrial nodes.

5. The non-transitory, computer-readable storage medium of claim 1, wherein the system is caused to:
configure applications of devices using the wireless TN to use sensor data stored at multiple nodes of the blockchain network other than the portion of the subset of the terrestrial nodes and non-terrestrial nodes that failed consensus.

6. The non-transitory, computer-readable storage medium of claim 1, wherein to re-effectuate the consensus protocol until the occurrence of the event comprises causing the system to:
determine that a time period has expired,
wherein the occurrence of the event corresponds to the expiration of the time period; and
in response to the determination that the time period has expired, terminate a next instance to effectuate the consensus protocol with the blockchain network.

7. The non-transitory, computer-readable storage medium of claim 1, wherein to re-effectuate the consensus protocol until the occurrence of the event comprises causing the system to:
determine that consensus was successful,
wherein the occurrence of the event corresponds to the determination that consensus was successful; and
in response to the determination that the consensus was successful, terminate a next instance to effectuate the consensus protocol with the blockchain network.

8. The non-transitory, computer-readable storage medium of claim 1, wherein to effectuate the consensus protocol comprises causing the system to:
cause direct communication of the data block using satellite links between satellites of the blockchain network,
wherein the consensus protocol is configured for low-latency communication over the satellite links.

9. The non-transitory, computer-readable storage medium of claim 1, wherein the multiple IoT devices form a mesh network configured to communicate the sensor data with intermediary terrestrial nodes configured to relay the sensor data directly to the one or more satellites.

10. The non-transitory, computer-readable storage medium of claim 1, wherein the multiple IoT devices are configured to transmit the sensor data directly to the non-terrestrial nodes of the blockchain network.

11. A method comprising:
receiving, over a wireless terrestrial network (TN), sensor data from multiple Internet of Things (IoT) devices,
wherein the TN includes one or more terrestrial nodes and is configured to couple to a non-terrestrial network (NTN) that includes one or more satellites;
causing communication of copies of the sensor data to multiple nodes of a blockchain network including at least a subset of the terrestrial nodes and non-terrestrial nodes;
effectuating a consensus protocol to initiate a process to record copies of a data block at each of the multiple nodes of the blockchain network,
wherein the data block is a block of the blockchain that includes at least an indication of the sensor data;
detecting a failed attempt at consensus with at least a portion of the subset of the terrestrial nodes and non-terrestrial nodes of the blockchain network; and
in response to the failed attempt at consensus, re-effectuating the consensus with the at least the portion of the multiple nodes of the blockchain network until occurrence of an event.

12. The method of claim 11 further comprising:
receiving location data of the IoT devices in addition to the sensor data;
causing communication of copies of the location data to the multiple nodes of a blockchain network; and
effectuating the consensus protocol to initiate the process to record copies of the data block, including the location data in addition to the sensor data, at each of the multiple nodes of the blockchain network.

13. The method of claim 11 further comprising:
determining a failed consensus with the one or more satellites; and
in response to the failed attempt of consensus with the one or more satellites, re-effectuating the consensus protocol with the one or more satellites.

14. The method of claim 11 further comprising:
determining a failed consensus with the one or more terrestrial nodes; and
in response to the failed consensus with the one or more terrestrial nodes, re-effectuating the consensus protocol with the one or more terrestrial nodes.

15. The method of claim 11 further comprising:
configuring applications of devices using the wireless TN to use sensor data stored at multiple nodes of the blockchain network other than the portion of the subset of the terrestrial nodes and non-terrestrial nodes that failed consensus.

16. The method of claim 11, wherein re-effectuating the consensus protocol until the occurrence of the event further comprising:
determining that a time period has expired,
wherein the occurrence of the event corresponds to the expiration of the time period; and
in response to the determination that the time period has expired, terminating a next instance to effectuate the consensus protocol with the blockchain network.

17. The method of claim 11, wherein re-effectuating the consensus protocol until the occurrence of the event further comprising:
determining that consensus was successful,
wherein the occurrence of the event corresponds to the determination that consensus was successful; and
in response to the determination that the consensus was successful, terminating a next instance to effectuate the consensus protocol with the blockchain network.

18. The method of claim 11, wherein effectuating the consensus protocol further comprising:
causing direct communication of the data block using satellite links between satellites of the blockchain network,
wherein the consensus protocol is configured for low-latency communication over the satellite links.

19. A system comprising:
at least one hardware processor; and
at least one non-transitory memory storing instructions, which, when executed by the at least one hardware processor, cause the system to:
receive, over a wireless terrestrial network (TN), sensor data from multiple Internet of Things (IoT) devices,
wherein the TN includes one or more terrestrial nodes and is configured to couple to a non-terrestrial network (NTN) that includes one or more satellites;
cause communication of copies of the sensor data to multiple nodes of a blockchain network including at least a subset of the terrestrial nodes and non-terrestrial nodes;
effectuate a consensus protocol to initiate a process to record copies of a data block at each of the multiple nodes of the blockchain network,
wherein the data block is a block of the blockchain that includes at least an indication of the sensor data;
detect a failed attempt at consensus with at least a portion of the subset of the terrestrial nodes and non-terrestrial nodes of the blockchain network; and
in response to the failed attempt at consensus, re-effectuate the consensus with the at least the portion of the multiple nodes of the blockchain network until occurrence of an event.

20. The system of claim 19, wherein the multiple IoT devices form a mesh network configured to communicate the sensor data with intermediary terrestrial nodes configured to relay the sensor data directly to the one or more satellites.
